(19) United States
(12) Patent Application Publication
(10) Pub. No.: US 2026/0309206 A1
(43) Pub. Date: Oct. 8, 2026

(54) SEISMIC RESTRAINT DEVICE FOR SUSPENDED ELEMENTS

(71) Applicant: SCUOLA UNIVERSITARIA SUPERIORE I.U.S.S., Pavia (IT)

(72) Inventors: Bryan CHALARCA ECHEVERRI, Pavia (IT); Daniele PERRONE, San Pietro in Lama (IT); André FILIATRAULT, Pavia (IT); Roberto NASCIMBENE, Pavia (IT)

(21) Appl. No.: 19/482,347

(22) PCT Filed: May 2, 2024
(86) PCT No.: PCT/EP2024/062123

§ 371 Date: Nov. 7, 2025

(30) Foreign Application Priority Data
May 8, 2023 (IT) 102023000009123

(51) Int. Cl. F16F 15/12

(52) U.S. Cl. CPC F16F 15/1208; F16F 15/1204; F16F 2222/12; F16F 2230/0005; F16F 2230/0076; F16F 2232/02

(57) ABSTRACT

A seismic restraint device for suspended elements, comprising: a suspension system fixed to a structure; a support frame for holding one or more suspended elements, the support frame hanging from the suspension system. The suspension system comprises: a first rotational joint configured for a first swing movement along a first plane, the first rotational joint comprising at least one damper for the first swing movement; a second rotational joint connected to the first rotational joint and configured for a second swing movement along a second plane, which is different from, and preferably perpendicular to, the first plane.

### TECHNICAL FIELD

The present invention relates to a seismic restraint device for suspended elements.

In general, the present invention may be applied in the anti-seismic field and in the field of supports for suspended elements, in particular non-structural suspended elements of a building.

### PRIOR ART

The recent progress in the structural engineering field allows the buildings to withstand moderate and strong seismic events, with small consequences on the structural system. However, also non-structural elements can be seriously affected by the seism, causing limited operation or occupancy for the building.

The non-structural suspended elements are acceleration-sensitive components which are usually fixed to the building's load-bearing structure above them (for example, pipe systems, cable trays, etc.).

Different factors accounts for the importance of the non-structural elements in the evaluation of seismic performance of a building: 1) the total cost of the non-structural elements might amount to up to 92% of the building's total investment, 2) the damaged non-structural elements may become a safety issue during a seismic event, not only because of their dangerousness, but also because of the obstruction of evacuation routes or because of the loss of danger-prevention functionalities (for example, damages to the fire-protection systems), and, finally, 3) the non-structural elements may become damaged even at low shaking intensities that would not affect the structural system.

Based on said factors, it is necessary to improve the seismic performance of the non-structural elements by reducing or eliminating the damages caused by the seism, thereby increasing the capability of total seismic resilience of the building.

Document EP2037147 (A1) relates to a friction damper for rapidly attenuating earthquake-generated vibrations of structures.

Document EP3084078 (A1) relates to a friction-damping device that allows to damp relative displacements, and in particular swing movements, between a first structural element and a second structural element of a structure.

Document JP6053530 (B2) relates to a friction damper that is installed in a structure to suppress and damp the vibration of the structure during an earthquake.

Document U.S. Pat. No. 11,447,949 (B2) relates to a friction damper to protect the structures from dynamic loads such as loads caused by an earthquake.

Document CN104652643 (B) relates to a self-reset high-energy-consumption shape-memory-alloy friction damper.

Document CN108442514 (B) relates to a flexible concrete frame joint structure with a hidden damper.

Document U.S. Pat. No. 10,563,418 (B2) relates to a multi-damper assembly for a building structure.

Document CN113585849 (B) relates to a two-stage friction damper having four long friction plates.

Document CN115596110 (A) relates to a composite damper, comprising a damper body, an energy dissipation component with two plates.

Document CN115522655 (A) relates to an occlusion rotary friction damper for stress absorption and isolation of buildings.

The scientific paper “Braceless seismic restraints for suspended nonstructural elements”, Bryan Chalarca, Andre Filiatrault, Daniele Perrone, Roberto Nascimbene, 3rd European conference on earthquake engineering & seismology, BUCHAREST, ROMANIA, September 2022, relates to a seismic restraint system for non-structural elements. Said system is composed of vertical hangers connected to rotational hysteretic dampers that work as the pivot of the system and provide supplemental damping to control the seismic response.

The scientific paper “Seismic Response of a Braceless Seismic Restraint System for Suspended Nonstructural Elements”, Bryan Chalarca, André Filiatrault, Daniele Perrone and Roberto Nascimbene, Fifth International Workshop on the Seismic Performance of Non-Structural Elements (SPONSE), December 2022, relates to a braceless seismic restraint for suspended nonstructural elements. The proposed system is composed of a vertical hanger connected to a rotational hysteretic damper that provides supplemental damping in the direction of interest to control the seismic response of the suspended non-structural element without the need for sway braces.

### SUMMARY OF THE INVENTION

An object of the present invention is to overcome drawbacks of the prior art.

A further particular object of the present invention is to improve the seismic performance of suspended elements, in particular of non-structural suspended elements.

A further particular object of the present invention is to increase the energy-dissipation ability of a seismic restraint system.

A further particular object of the present invention is to reduce residual deformations and damages induced on a seismic restraint system in the event of an earthquake.

A further particular object of the present invention is to improve the architectural integration of non-structural suspended elements thereby reducing the area required for the installation of a seismic restraint system.

These and other objects are achieved by a seismic restraint device for suspended elements according to the features of the appended claims, which are integral part of the present description.

An idea underlying the present invention is to provide the seismic restraint device for suspended elements.

The seismic restraint device comprises at least one suspension system configured for fixing to a structure.

The seismic restraint device comprises a support frame configured for holding one or more suspended elements. The support frame hangs from the at least one suspension system.

The suspension system comprises a first rotational joint configured for a first swing movement along a first plane. The first rotational joint comprises at least one damper for the first swing movement.

The suspension system comprises a second rotational joint connected to the first rotational joint and configured for a second swing movement along a second plane. The second plane is different from, and preferably perpendicular to, the first plane.

Preferably, the at least one damper for the first swing movement comprises rotating plates and a friction insert interposed between said plates, thereby making a compact, effective friction damper.

Preferably, the second rotational joint comprises a simple hinge to provide the second swing movement in an undamped manner.

The seismic restraint device does not require lateral brackets or wind-braces, and has an operation similar to a pendulum consisting of a vertical hook connected to a rotational spring at the upper end, or first rotational joint, which behaves like a damper and controls the maximum stress and the energy dissipation of the system.

The at least one damper of the first rotational joint is fixed to the load-bearing structure, preferably by means of a hinge connection, or second rotational joint, thereby allowing the rotation about the direction that is out of plane with respect to the rotation of the damper so that the seismic restraint device can be used as a transverse or longitudinal constraint for the suspended element.

Due to its pendulum-like behavior, the seismic restraint device does not need any additional reinforcement, thereby reducing the area required for its installation.

The damping provided by the damper, in particular a friction damper, allows to control the maximum system response, with low, if any, induced damage or residual deformation.

During a seismic event, once the induced seismic force exceeds the activation force of the at least one damper, in particular, in the case of a friction damper, equivalent to the static friction coefficient multiplied by the normal stress, the system starts to rotate about the first and the second rotational joints, respectively, said joints representing the system's rotation axes.

This controlled and damped rotation allows energy dissipation, in particular through the generated friction heat. In the case of at least one friction or heat damper, there is no anelastic response of the elements that constitute the seismic restraint device, and the latter does not show any damage after the seismic event.

In particular, the suspended non-structural element can be centered again in its original position by applying a centering force or by releasing the normal stress on the friction insert.

Advantageously, the seismic restraint device allows to avoid the need for brackets to control lateral displacements, thereby reducing the area required for the installation.

Advantageously, the seismic restraint device provides an anelastic response, preferably concentrated on the dampening element, minimizing or eliminating permanent deformations or damages induced on the support elements.

Advantageously, the seismic restraint device allows to control the maximum deformations by adding a supplemental damping, instead of increasing the lateral stiffness of the assembly. In this way, by reducing the difference of stiffness between the suspended non-structural element and the lateral constraint, the local dynamic response on the non-structural element is decreased.

Advantageously, the seismic restraint device allows to remove a residual deformation after a seismic event by simply applying a centering force or by releasing a normal stress acting on the friction damper. In some cases, the acting gravitational force alone might be sufficient.

Advantageously, the seismic restraint device can be easily configured or resized based on the design requirements.

Further features and advantages will become clearer from the detailed description given herein below of preferred non-limiting embodiments of the present invention, and from the dependent claims that outline preferred and particularly advantageous embodiments of the invention.

### BRIEF DESCRIPTION OF THE DRAWINGS

The invention is illustrated with reference to the following figures, which are provided by way of non-limiting example, where:

FIG. 1 shows suspended elements suspended by seismic restraint devices.

FIG. 2 shows a first seismic restraint device.

FIG. 3 shows a second seismic restraint device.

FIG. 4 shows the second seismic restraint device of FIG. 3 in a disassembled configuration.

FIG. 5 shows a third seismic restraint device.

FIG. 6 shows a fourth seismic restraint device.

FIG. 7 shows a fifth seismic restraint device.

FIG. 8 shows a sixth seismic restraint device.

FIG. 9 shows a seventh seismic restraint device.

In the different figures, analogous elements will be identified by analogous reference numerals. If there is a plurality of the same elements in a figure, for simplicity of illustration, only some of them will be indicated by a respective reference, being it understood that the others are comprised by analogy.

### DETAILED DESCRIPTION

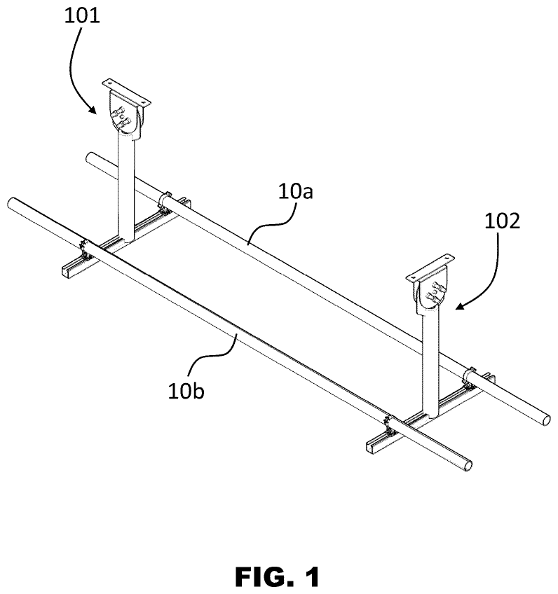

FIG. 1 shows non-structural suspended elements 10a and 10b, which are suspended by means of a pair of seismic restraint devices 101 and 102.

The suspended elements 10a and 10b schematically represent pipes or raceways for the passage of utilities, for example water supply, power supply, pneumatic supply, and the like. In this sense, the suspended elements 10a and 10b represent “non-structural” elements, since they do not contribute to the structural strength of the building in which they are installed, but they represent accessory systems thereof.

In other examples, not shown, there might be a higher or lower number of differently configured suspended elements.

The suspended elements 10a and 10b are supported, in their extension, by two seismic restraint devices 101 and 102 that will be described in more detail below.

In particular, the seismic restraint devices 101 and 102 comprise at least one suspension system fixed to a structure, such as for example a floor slab or a horizontal bearer beam of a building, and also a support frame, configured for holding the suspended elements 10a and 10b. These components will be described in more detail below.

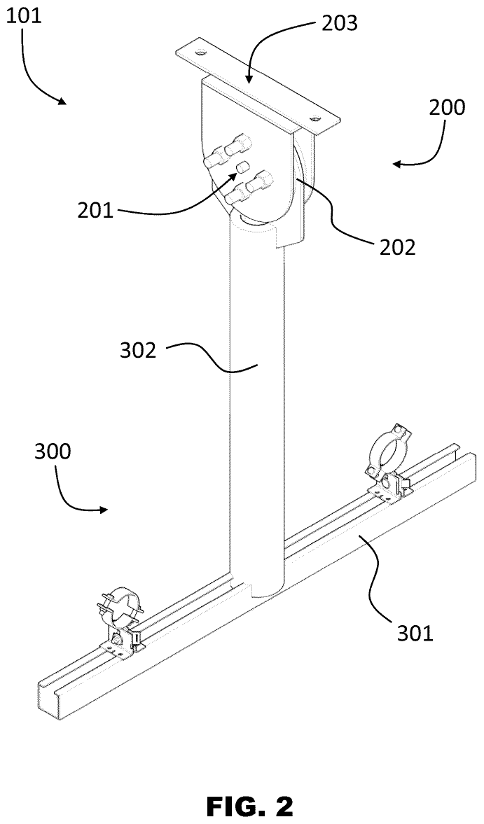

FIG. 2 shows the seismic restraint device 101 in more detail.

The seismic restraint device 101 comprises at least one suspension system 200 configured for fixing to an external structure that supports it.

The seismic restraint device 101 comprises a support frame 300, for example made of metal. The support frame 300, configured for holding the suspended elements, hangs from the at least one suspension system 200, thereby completing the seismic restraint device.

The at least one suspension system 200 comprises a first rotational joint 201, configured for a first swing movement along a first plane. The first rotational joint comprises at least one damper 202 for said first swing movement.

The at least one suspension system 200 comprises a second rotational joint 203, connected to the first rotational joint 201 and configured for a second swing movement, along a second plane which is different from the first plane. In particular, the second plane is preferably perpendicular to the first plane, as it is in the shown example.

The second rotational joint 203 is positioned above the first rotational joint 201, so as to be fixed to the external structure, that supports the entire assembly and bears the load of the suspended elements, for example of the suspended elements 10a and 10b.

During a seismic event, once the induced seismic force is greater than the force of activation of the damper 202, the support frame 300 starts rotating about the first rotational joint 201 and about the second rotational joint 203, said rotational joints representing the system's rotation axes, which are preferably perpendicular to each other.

The rotation about the rotational joints 201 and 203, which is controlled through the damper 202, allows dissipation of seismic energy. At the end of the seismic event, the support frame 300 can be centered again in its original position, by simple gravity effects, or by applying a centering force or by releasing the damper 202.

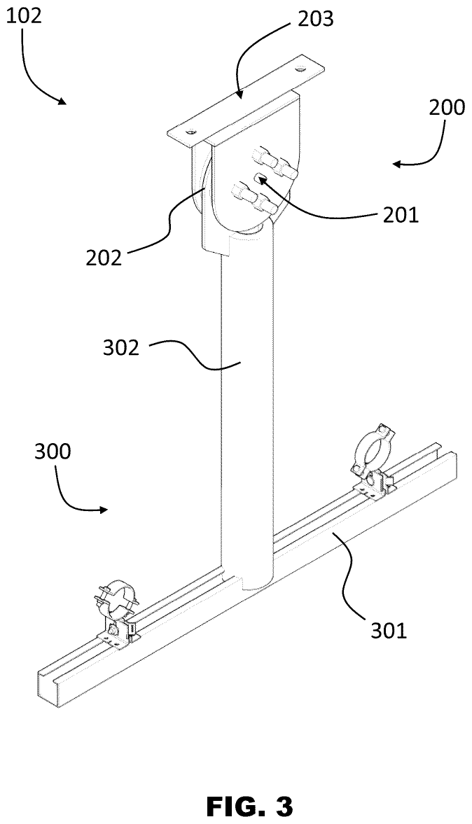

FIG. 3 shows the seismic restraint device 102 in more detail.

The support frame 300 preferably comprises an elongated beam 301, which is transversally connected to at least one upright support element 302.

As already described, the elongated beam 301 is preferably configured for holding the suspended elements 10a and 10b.

The at least one upright support element 302 is connected to the at least one suspension system 200.

In particular, the seismic restraint device 102, or 101, defines an inverted-T configuration for the support frame 300.

The elongated beam 301 may develop along the same first plane of the swing movement of the first rotational joint 201, as in the case of the seismic restraint device 102.

Alternatively, the elongated beam 301 may develop along the same second plane of the swing movement of the second rotational joint 203, as in the case of the seismic restraint device 101 already described.

In this way, the seismic restraint device provides a movement that is longitudinally damped, as in example 101, or transversally damped, as in example 102. A suitable combination of the seismic restraint devices 101 and 102, for example a longitudinal one and a transverse one as in FIG. 1, allows thus the seismic restraint of the suspended elements on more planes.

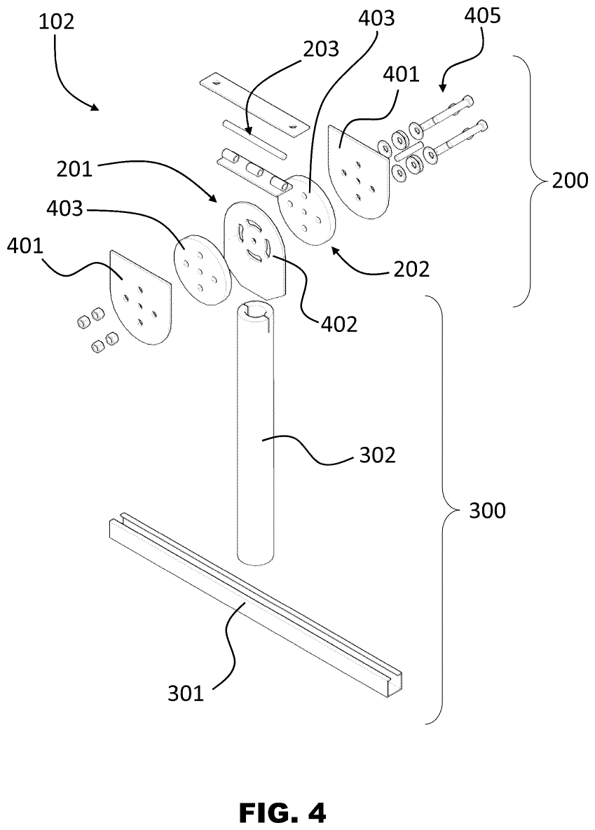

FIG. 4 shows the second seismic restraint device 102 in a disassembled configuration and with some components that are further divided for a better understanding.

The at least one damper 202 for the first swing movement, already described, comprises at least one first plate 401 rotationally constrained with the second rotational joint 203, in particular integral with the second rotational joint 203.

The at least one damper 202 comprises at least one second plate 402 rotationally constrained with the support frame 300, in particular integral with the upright support element 302.

The at least one damper 202 comprises at least one friction insert 403, interposed between the at least one first plate 401 and the at least one second plate 402.

The at least one damper 202 comprises a clamping system 405. In this example, the clamping system 405 comprises four bolted joints passing through the at least one first plate 401, the at least one second plate 402 and the at least one friction insert 403; being it understood that a different number of bolted joints may be provided.

In general, the clamping system 405 is configured for clamping the at least one friction insert 403 between the at least one first plate 401 and the at least one second plate 402. Thanks to the normal stress acting on the friction insert 403 and adjusted by the force given by the clamping system 405, the latter is configured for providing friction by action of the first swing movement about the first rotational joint 201.

Therefore, the example of the damper 202 presented herein represents a “friction damper”, which allows to make a compact device thanks to the fact that the energy-dissipation ability is efficiently generated through the friction between two surfaces. Moreover, the activation force can be easily modified on site during the installation of the seismic restraint device, by suitably adjusting the clamping system 405.

Preferably, but without limitation, the at least one friction insert 403 comprises a substantially circular pad. Preferably, but without limitation, the at least one friction insert 403 is made of non-metallic friction material.

In the preferred but non-limiting configuration shown in FIG. 4, the at least one first plate indeed comprises a pair of first plates 401, and the at least one friction insert indeed comprises a pair of friction inserts 403, respectively on both sides of the at least one second plate 402. This configuration is very advantageous for load distributions, but it is not excluded that other, even asymmetrical, configurations can be provided.

Preferably, the second rotational joint 203 comprises a hinge for the second swing movement. The simple hinge, made by means of a pivot joining the respective annular seats, provides a second swing movement which is substantially undamped.

In general, to make the seismic restraint devices, the sizes and the number of steel plates, of friction inserts, of bolted joints, etc., depend on the design requirements and on the acting forces, both in terms of static load and of dynamic stress due to seismic effects.

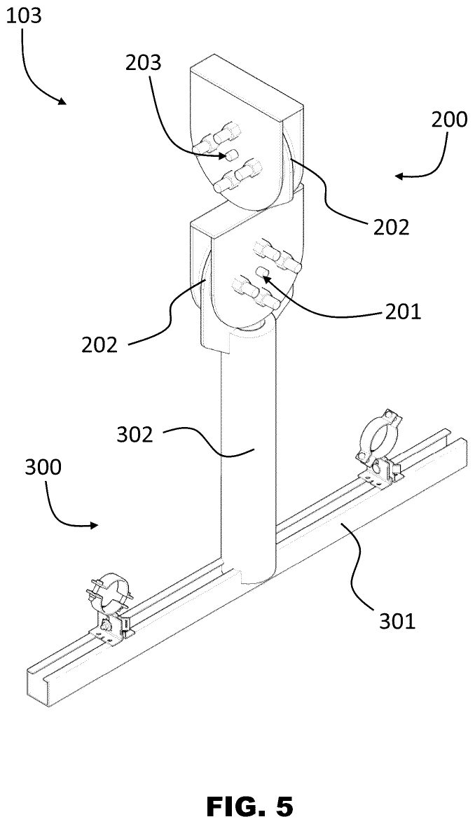

FIG. 5 shows a seismic restraint device 103, wherein the second rotational joint 203 comprises a second damper 202 for the second swing movement. Preferably, the second damper 202 is analogous to the at least one previously described damper 202, but with a rotation plane perpendicular to the other one. In this way, it is possible to provide a single support providing energy dissipation and therefore the seismic restraint in the longitudinal and transverse direction.

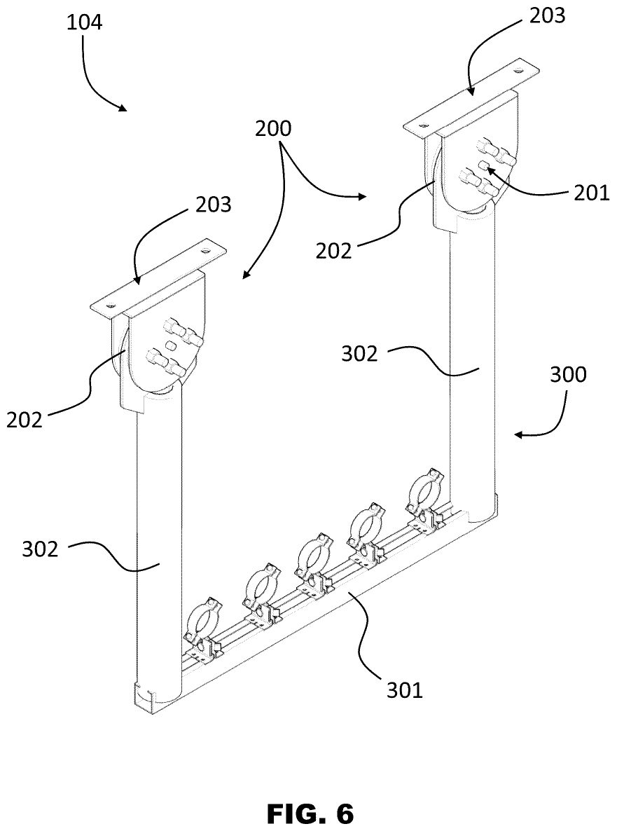

FIG. 6 shows a seismic restraint device 104, wherein the suspension system 200 comprises two (but they could be more) corresponding suspension systems 200.

The suspension systems 200 are respectively configured for fixing to the external structure, and, similarly to what has been already described, each include: a first rotational joint 201, at least one damper 202, a second rotational joint 203.

Therefore, the support frame 300 hangs from the corresponding suspension systems 200, with two upright supports ending in an elongated beam 301, thereby making a substantially U-shaped structure.

The seismic restraint device 104 is very recommended in the case of load unbalance or of high gravity loads on the suspended elements.

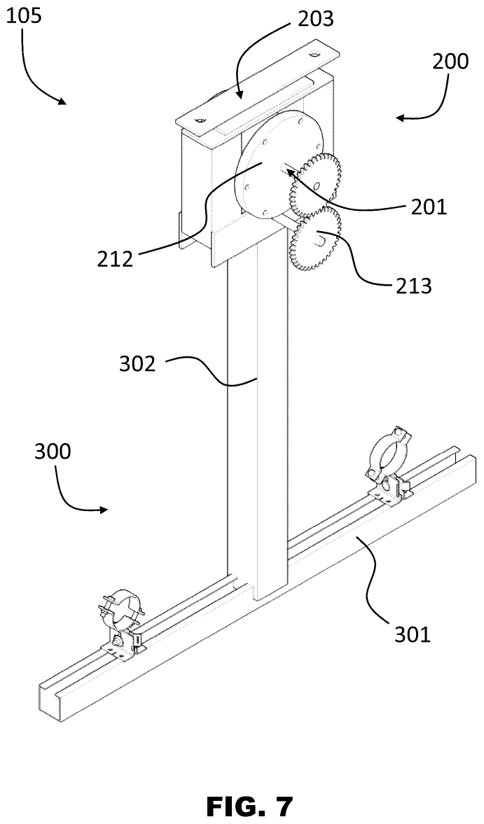

FIG. 7 shows a seismic restraint device 105, wherein there is a different at least one damper 212 for the first swing movement. In particular, at least one damper 212 comprises a rotational viscous damper, typically based on effects of hydraulic/pneumatic dissipation of oil or the like.

The seismic restraint device 105 comprises a gear transmission 213, suitable for transferring the first swing movement from the support frame 300 to the rotational viscous damper 212. Indeed, a rotational viscous damper is generally not capable of withstanding shearing forces, axial forces or other external forces in addition to the rotation movement. The addition of the further gears 213 allows to transfer the rotational movement in a way that the elements of the system can bear better.

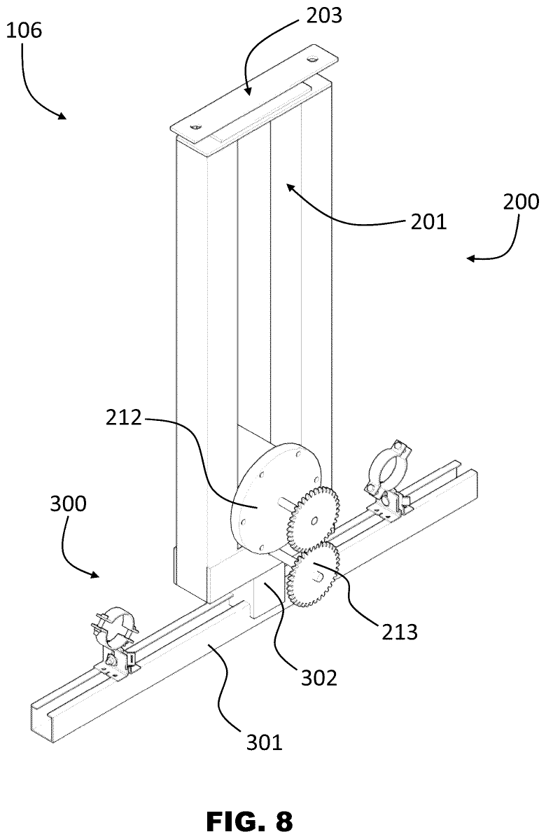

FIG. 8 shows a seismic restraint device 106 representing a variant of the seismic restraint device 105 which has already been described. The seismic restraint device 106 provides a longer element connecting the first rotational joint 201 and the second rotational joint 203, to accommodate the rotation movement of the elongated beam 301. On the other hand, the rotational viscous damper 212 is positioned lower, and the upright support element 302 has a minimized length.

The examples, in the extreme case when the overall dimensions are equal, of the seismic restraint devices 105 and 106 help to understand that, in general, the geometry and the distribution of the device (for example, the length of the pendulum's arm) affect the calculation of the properties of the rotational damper, thereby changing its costs and feasibility. For example, the length of the pendulum's arm clearly affects the necessary damping constant for the rotational viscous damper.

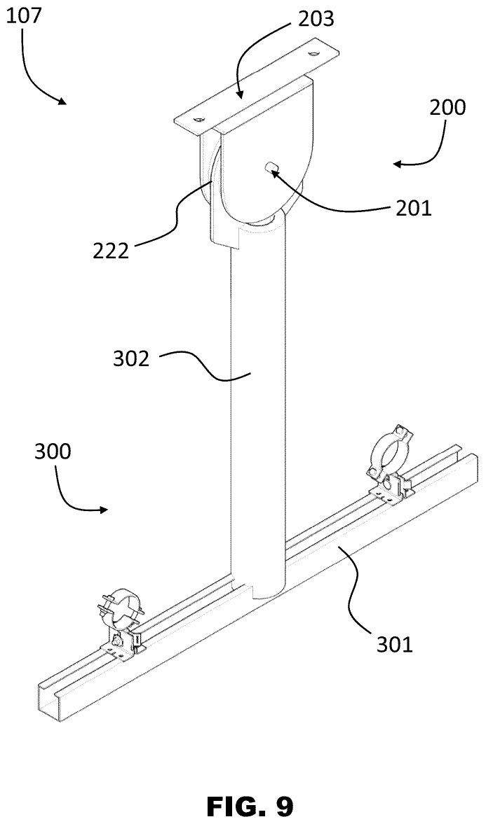

FIG. 9 shows a seismic restraint device 107, which comprises the at least one damper 222 for the first swing movement provided with a deformable element made of a material having viscoelastic behavior. Therefore, the viscoelastic damper 222 is an alternative to the friction damper 202.

### INDUSTRIAL APPLICABILITY

The seismic restraint device of the present invention may be applied in the field of construction, especially in the seismic design of suspended non-structural elements such as suspended water pipes, cable trays, lighting systems, air ducts, etc.

Due to the requirements of the building regulations, non-structural suspended elements are required to withstand certain levels of seism-induced movements, in order to protect the occupants and the functionality of the key systems of a building.

The seismic restraint device of the present invention may be implemented to replace traditional solutions in a rapid and effective way, especially where higher seismic performance is required or in congested non-structural layouts where there is no room to add other types of reinforcement elements.

Considering the description reported herein, a person skilled in the art can devise further modifications and variants, for the purpose of satisfying specific and particular requirements.

For example, the seismic restraint device might be enlarged or resized based on design requirements.

Moreover, the proportions of the seismic restraint device, in particular the vertical dimension with respect to the position of the rotational joint or of the rotational joints, may be adjusted based on requirements of the installation layout and of seismic protection.

In general, elements described with reference to some figures can be combined with different elements described with reference to other figures, for example by replacing them, if there is no technical prejudice that is evident to the person skilled in the art.

The embodiments described herein are thus to be understood as non-limiting examples of the invention.

1. A seismic restraint device for suspended elements, comprising:
at least one suspension system configured for fixing to a structure;
a support frame configured for holding one or more of said suspended elements, said support frame hanging from said at least one suspension system;
wherein said at least one suspension system comprises:
a first rotational joint configured for a first swing movement along a first plane, said first rotational joint comprising at least one damper for said first swing movement,
a second rotational joint connected to said first rotational joint and configured for a second swing movement along a second plane, said second plane being different from, preferably perpendicular to, said first plane.

2. The seismic restraint device according to claim 1, wherein said at least one damper for said first swing movement comprises:
at least one first plate rotationally constrained with said second rotational joint,
at least one second plate rotationally constrained with said support frame,
at least one friction insert interposed between said at least one first plate and said at least one second plate,
a clamping system configured for clamping said at least one friction insert between said at least one first plate and said at least one second plate, configured for providing friction by action of said first swing movement.

3. The seismic restraint device according to claim 2, wherein said at least one friction insert comprises a substantially circular pad, preferably in non-metallic friction material.

4. The seismic restraint device according to claim 2, wherein said at least one first plate comprises a pair of first plates and wherein said at least one friction insert comprises a pair of friction inserts, respectively on both sides of said at least one second plate.

5. The seismic restraint device according to claim 2, wherein said clamping system comprises one or more bolted joints passing through said at least one first plate, said at least one second plate and said at least one friction insert.

6. The seismic restraint device according to claim 1, wherein said at least one damper (212) for said first swing movement comprises a rotational viscous damper.

7. The seismic restraint device according to claim 6, further comprising a gear transmission transferring said first swing movement from said support frame to said rotational viscous damper.

8. The seismic restraint device according to claim 1, wherein said at least one damper for said first swing movement comprises a deformable element of material having a viscous-elastic behavior.

9. The seismic restraint device according to claim 1, wherein said second rotational joint comprises a hinge for said second swing movement, said hinge providing said second swing movement undamped.

10. The seismic restraint device according to claim 1, wherein said second rotational joint comprises a second damper for said second swing movement.

11. The seismic restraint device according to claim 1, wherein said second rotational joint is positioned above said first rotational joint, said second rotational joint being configured for fixing to said structure.

12. The seismic restraint device according to claim 1, wherein said support frame comprises an elongated beam transversally connected to at least one upright support element, said elongated beam being configured for holding said one or more of said suspended elements, said at least one upright support element being connected to said at least one suspension system preferably according to an inverted-T configuration.

13. The seismic restraint device according to claim 12, wherein said elongated beam develops along said first plane or develops along said second plane, providing a longitudinally or transversally damped movement.

14. The seismic restraint device according to any claim 1, wherein said at least one suspension system comprises two or more of corresponding suspension systems, respectively configured for fixing to said structure, said support frame hanging from said corresponding suspension systems.
